(19) United States
(12) Patent Application Publication
(10) Pub. No.: US 2025/0247578 A1
(43) Pub. Date: Jul. 31, 2025

(54) MANAGEMENT OF THE RENDERING OF AN ITEM OF MULTIMEDIA CONTENT

(71) Applicant: ORANGE, Issy-les-Moulineaux (FR)

(72) Inventors: Mathieu RIVOALEN, Chatillon (FR); Hervé MARCHAND, Chatillon (FR)

(21) Appl. No.: 18/859,819

(22) PCT Filed: Apr. 19, 2023
(86) PCT No.: PCT/EP2023/060147

§ 371 Date: Oct. 24, 2024

(30) Foreign Application Priority Data
Apr. 25, 2022 (FR) FR2203794

(51) Int. Cl. H04N 21/431; H04N 21/462; H04N 21/4725

(52) U.S. Cl. CPC H04N 21/4312; H04N 21/4621; H04N 21/4725

(57) ABSTRACT

A method for managing the rendering of content on a screen. The content has several qualities available for selection. The rendering of the content is associated with a selection interface including at least one selection zone associated with a function and capable of being manipulated by using a cursor. When the content is rendered, the quality selected for the rendering of the content is a function of a state of the cursor in conjunction with the selection interface.

### CROSS-REFERENCE TO RELATED APPLICATIONS

This application is a Section 371 National Stage Application of International Application No. PCT/EP2023/060147, filed Apr. 19, 2023, published as WO 2023/208688 on Nov. 2, 2023, not in English, which claims priority to French Patent Application No. FR2203794, filed Apr. 25, 2022, the contents of which are incorporated herein by reference in their entireties.

### TECHNICAL FIELD

The field of the invention is that of managing the rendering of digital multimedia content, namely digital audio and/or video content. More specifically, the invention relates to managing the rendering of multimedia content when this content is rendered at the same time as a selection interface on the screen. It will be seen hereafter that rendering content and the selection interface can be carried out on the same screen or on two separate screens.

The invention particularly relates to content that is accessible in several formats associated with respective byte sizes with more or less impact on the bandwidth of the network over which the content is downloaded. The invention particularly relates to content downloaded according to a technique called adaptive progressive downloading, or HAS, or any other downloading techniques using the same principle.

The invention applies to any system in which simultaneous rendering of multimedia content and of a selection interface. Such a system is, for example, a TV decoder, a Web TV, a smart television, a digital television decoder, etc.

A selection interface relates to a graphical interface comprising selectable tabs associated with respective functions, such as access to content being broadcast (called live content), access to an integrated recorder, access to on-demand content, access to settings, etc.

As indicated above, the selection interface can be rendered on the same screen as the content being downloaded, or on a remote screen.

### PRIOR ART

Access to multimedia content, such as on-demand television or video, from an Internet type network, is currently possible for most rendering terminals, notably when they belong to a local communication network, such as a home network.

The terminal generally transmits a request to a server, indicating the selected content; in response, the terminal receives a digital data stream relating to this content. Within the context of a local communication network, such a request passes through the network access gateway, for example, the residential gateway.

The terminal is adapted to receive digital content in the form of multimedia data and to request rendering of this content on a rendering device. The received data corresponding to a video is generally decoded, then rendered in the form of a display of the corresponding video with its associated sound band. Hereafter, for the sake of simplification, the digital content will be considered to be a video and the rendering by the terminal, or the consumption by the user of the terminal, will be considered to be a display on the screen of the terminal.

Broadcasting digital content over the Internet is often based on client-server protocols from the HTTP (Hypertext Transport Protocol) family. In particular, downloading digital content in progressive mode, also called streaming, allows the data to be conveyed and consumed in real-time, i.e., the digital data is transmitted over the network and rendered by the terminal as it arrives. The terminal receives and stores some of the digital data in a buffer memory before rendering it. This distribution mode is particularly useful when the bit rate available to the user is not guaranteed for real-time transfer of video.

Adaptive progressive downloading, called HTTP Adaptive Streaming, abbreviated to HAS, also allows data to be broadcast and received according to various qualities corresponding to different bit rates, for example. These various qualities are described in a description file, called “manifest” by a person skilled in the art, available for download on a data server, for example, a content server. When the client terminal wishes to access content, this description file allows the correct format to be selected for the content to be consumed as a function of the available bandwidth or of the storage and decoding capabilities of the client terminal. This type of technique notably allows variations in bandwidth to be taken into account on the link between the client terminal and the content server.

Several technical solutions exist for facilitating the distribution of such streaming content, such as, for example, the proprietary solutions Microsoft® Smooth streaming, Apple® HLS, Adobe® HTTP Dynamic Streaming or even the MPEG-DASH standard of the ISO/IEC body that will be described below. These methods propose sending the client one or more intermediate description files, also called documents or “manifests”, containing the addresses of the various segments with the various qualities of the multimedia content.

Thus, the MPEG-DASH (“Dynamic Adaptive Streaming over HTTP”) standard is a formatting standard for audiovisual broadcasting over the Internet. It is based on preparing content as different presentations with variable quality and with a variable bit rate, divided into short duration segments (of the order of a few seconds), also called segments. Each of these segments is made individually available by means of an exchange protocol. The protocol that is mainly targeted is the HTTP protocol, but other protocols (for example, FTP) can also be used. The organization of the segments and the associated parameters are published in a manifest in XML format.

The principle underlying this standard is that the client terminal estimates the bandwidth available for receiving the segments, and, depending on the replenishment of its reception buffer, selects, for the next segment to be loaded, a representation whose bit rate ensures the best possible quality, and allows a reception delay that is compatible with the uninterrupted rendering of the content.

Thus, in order to adapt to the variation in the network conditions, notably in terms of bandwidth, the existing adaptive downloading solutions allow the client terminal to transition from a version of the content encoded at a certain encoding bit rate, to another version encoded at another bit rate, during downloading. Indeed, each version of the content is divided into segments of the same duration. In order to allow continuous rendering of the content on the terminal, each segment must reach the terminal before its programmed rendering time. The perceived quality associated with a segment increases with the size of the segment, expressed in bits, but at the same time larger segments require a longer transmission time, and therefore have an increased risk of not being received in time for continuous rendering of the content.

Therefore, the rendering terminal must find a compromise between the overall quality of the content and its uninterrupted rendering, by carefully selecting the next segment to be downloaded, from among the various proposed encoding bit rates. To this end, various algorithms exist for selecting the quality of the content as a function of the available bandwidth, which can have more or less aggressive or more or less secure strategies.

Current techniques therefore constantly attempt to offer optimal image quality. This optimization thus allows good quality streams to be received when allowed by the network conditions.

However, the use of a graphical selection interface rich in graphical elements and provided with graphical animations, such as displaying a cursor for selecting functions displayed on the interface, use significant CPU (or processor) resources. One problem is that decoding segments associated with high encoding bit rates uses the processor a considerable amount and can have a negative impact on the use of the interface, which then has less available CPU resources; the interface can become less responsive, for example, the cursor moves more slowly. This lack of responsiveness results in a selection interface that is less user friendly.

Furthermore, offering optimal image quality is not always prudent, particularly when the user in front of the screen rendering the content focuses their attention on the graphical interface.

The invention improves the situation.

### SUMMARY

The invention relates to a method for managing the rendering of content on a screen, with the content having several qualities available for selection, the rendering of the content being associated with a selection interface, characterized in that, when the content is rendered, the quality selected for rendering the content is a function of a datum representing an interaction with the selection interface.

According to the invention, the rendered content is therefore a function of a datum representing an interaction and therefore an activity in conjunction with the selection interface.

It will be seen hereafter, in one example, that the datum representing an interaction is derived from a location of a cursor on the screen, a mobility state of the cursor, etc. Thus, if content is being rendered, then, depending on the state of the cursor, the content is replaced by other content (an image, another video, the same video but by selecting other encoding bit rates, etc.).

According to a first embodiment of the method, the content can be downloaded from a communication network; the content is divided into several segments, with the segments having several selectable encoding bit rates; in this configuration, the state of the cursor determines the encoding bit rate of the segments to be selected for the future segments. By virtue of this embodiment, the value of the encoding bit rate selected by the reading terminal for downloading future segments therefore can be, under certain circumstances, less than the encoding bit rate value that would be obtained with conventional techniques for obtaining the encoding bit rate based on the current bandwidth. This reduction results in local CPU resources being saved and therefore increases the responsiveness of the selection interface. A further result of this reduction in the encoding bit rate is an increase in the current bandwidth and therefore an improvement in the network conditions for the other services (Internet access, VOD, etc.) that compete with content downloading in terms of bandwidth.

For example, when the state of the cursor reveals that the user no longer wishes to continue reading the content, the bit rate can be decreased in this case. This reduction results in a reduction in the bandwidth that the segments occupy when downloading. Furthermore, this reduction maintains an optimal user experience because, at this time, the user seems to have lost interest, or even is no longer interested in, the content currently being rendered, but rather is interested in functions offered by the selection interface. The user no longer views the content and therefore does not notice the reduction in the quality of the content being rendered.

According to a second particular embodiment of the invention, which can be implemented alternatively or cumulatively with the previous embodiment, the determined encoding bit rate is less than the current encoding bit rate. In this first embodiment, the second encoding bit rate is conventionally determined as a function of the current bandwidth, as explained in the section dedicated to the prior art. Then, a first bit rate simply needs to be selected that is lower than the second bit rate in order to obtain the same advantages as the first embodiment described above.

According to a third particular embodiment of the invention, which can be implemented alternatively or cumulatively with the previous embodiments, the determined encoding bit rate is the smallest selectable encoding bit rate. This second embodiment simplifies the method by selecting the lowest encoding bit rate. This simplification avoids a step of determining the encoding bit rate as a function of the bandwidth; this embodiment therefore considerably reduces the processing time, in order to obtain the encoding bit rate to be used for the future segments because the selected bit rate is quite simply the lowest bit rate.

According to a fourth particular embodiment of the invention, which can be implemented alternatively or cumulatively with the previous embodiments, the state is a movement of the cursor on the selection interface. Indeed, a simple movement of the cursor, without confirming a function offered by a tab in the selection zone, is evidence of an interest in placing the cursor on a zone of the selection interface; navigation through the graphical interface proves that the attention of the use relates to the interface and less so to the content.

According to a fifth particular embodiment of the invention, which can be implemented alternatively or cumulatively with the previous embodiments, the state is a location of the cursor relative to said at least one selection zone of the selection interface. A location allows the zone highlighted by the cursor to be identified, meaning the corresponding tab, and the function associated with this zone or tab. For example, if the tab in question relates to access to settings (setting parental controls, setting a rendering language, etc.), in this case, it can be considered that the user manipulating the cursor is no longer at all interested in the content; a reduction in the encoding bit rate is prudent in this case; conversely, if the tab in question relates to access to the channel for accessing the settings, in this case it can be considered that the user manipulating the cursor is no longer at all interested in the content; reducing the encoding bit rate is prudent in this case.

According to a sixth particular embodiment of the invention, which can be implemented alternatively or cumulatively with the previous embodiments, the selection interface comprises at least one selection zone associated with a function; if the content being rendered is a given type of content, and if the function associated with the zone relates to access to said type of content being rendered, in this case, the encoding bit rate is a maximum possible bit rate as a function of the current bandwidth. For example, if the content being rendered is live broadcast content, and if the tab of the selection interface relates to access to live content, the entity will request access to optimum quality segments. In other words, if the quality has dropped due to a state of the cursor as indicated above, as soon as the cursor is placed on a type of tab relating to the rendered content, the entity returns to normal operation.

According to a hardware aspect, the invention relates to an entity for managing the rendering of content on a screen, with the content having several qualities available for selection, the rendering of the content being associated with a selection interface comprising at least one selection zone associated with a function and capable of being manipulated by means of a cursor, characterized in that it comprises a selection module able to select, when the content is rendered, the quality for rendering the content as a function of a state of the cursor.

According to another hardware aspect, the invention relates to a reader terminal comprising a management entity as defined above.

According to another hardware aspect, the subject matter of the invention is a computer program able to be implemented on a management entity as defined above, with the program comprising code instructions, which program, when it is executed by a processor, carries out the steps of the method defined above.

According to another hardware aspect, the subject matter of the invention is a data medium storing at least one series of program code instructions for executing a management method as defined above.

The medium in question can be any entity or device capable of storing the program. For example, the medium can comprise a storage means, such as a ROM, for example, a CD-ROM or a microelectronic circuit ROM, or even a magnetic storage means, for example, a hard disk. Furthermore, the information medium can be a transmissible medium such as an electrical or optical signal, which can be conveyed via an electrical or optical cable, by radio or by other means. The program according to the invention particularly can be downloaded over a network of the Internet type. Alternatively, the information medium can be an integrated circuit in which the program is incorporated, with the circuit being adapted to execute or to be used to execute the method in question.

### BRIEF DESCRIPTION OF THE DRAWINGS

The invention will be better understood upon reading the following description, which is provided by way of an example, and with reference to the appended drawings, in which:

FIG. 1 shows an architecture for progressively downloading over the Internet based on the use of adaptive streaming according to one embodiment of the method of the invention;

FIG. 2 schematically illustrates the hardware structure of a real-time multimedia stream reader terminal integrating a device for managing adaptive progressive downloading according to one embodiment of the invention;

FIG. 3 illustrates content and its various segments;

FIG. 4 illustrates a possible embodiment for rendering content and a selection interface on the same screen;

FIG. 5 shows another possible embodiment for rendering content and a selection interface on the same screen;

FIG. 6 shows the evolution of the encoding bit rate used for the main content according to one embodiment of the method of the invention;

FIG. 7 illustrates a state of the screen at a given instant t1;

FIG. 8 illustrates a state of the screen at a subsequent given instant t2;

FIG. 9 illustrates a state of the screen at a subsequent given instant t3.

### DETAILED DESCRIPTION OF ILLUSTRATIVE EMBODIMENTS OF THE INVENTION

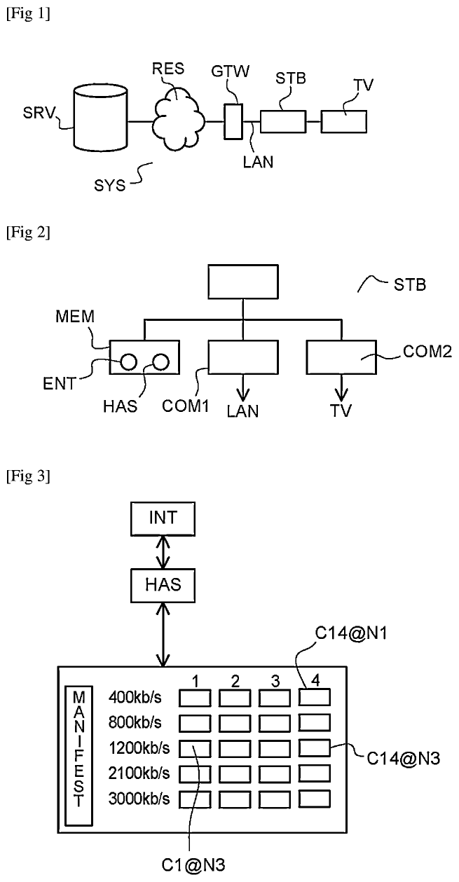

An architecture for downloading multimedia content will now be described with reference to FIG. 1.

In this example, the downloading is of the progressive type based on the use of HAS adaptive streaming. Again, it should be noted that the invention is not limited to HAS technology, but extends to all other data downloading technologies.

A digital content server SRV is located, according to this example, in the wide area network WAN, but it equally could be located in a home gateway or any other equipment capable of hosting such a content server.

The content server SRV receives, for example, digital television content channels originating from a television broadcast network, not shown, and/or on-demand videos, and makes them available to client terminals.

A client reading terminal, for example, a decoder, can start communicating with the content server SRV in order to receive one or more items of content (films, documentaries, advertising sequences, etc.).

The client terminals can be any kind of client terminals, for example, a decoder STB, a computer PC, a mobile telephone MOB, etc.

The embodiments are based on a decoder STB.

Frequently, in this client-server context, an adaptive progressive downloading technique, called “adaptive streaming”, abbreviated to HAS and based on the HTTP protocol, is used for exchanging data between a client terminal STB and the server SRV. This type of technique notably allows the user to be offered good quality content, while taking into account variations in bandwidth that can occur on the link between the client terminal STB, and a service gateway, and/or between the service gateway and the content server SRV.

Conventionally, as will be seen with reference to FIG. 3, various qualities can be encoded for the same content of a channel, corresponding, for example, to different encoding bit rates. More generally, reference will be made to quality for referring to a given resolution of the digital content (spatial resolution, temporal resolution, quality level associated with video and/or audio compression) with a certain encoding bit rate. Each quality level is itself divided into time segments on the content server (also called content “segments” by a person skilled in the art).

The description of these various qualities and of the associated temporal segmentation, as well as the content segments, are described for the client terminal and made available via their Internet addresses (URI: Universal Resource Identifier). All these parameters (qualities, addresses of the segments, etc.) are generally consolidated in a parameter file, called description file or “manifest”. It should be noted that this parameter file can be a computer file or a set of information describing the content, accessible at a certain address.

The reader terminal STB, in a progressive adaptive downloading context, can adapt the access requests that it transmits to the server in order to receive and decode the content requested by the user at the quality that best corresponds thereto. In this example, if the content is available at the following bit rates 400 kb/s (kilobits per second) (Resolution 1, or level 1, denoted N1), 800 kb/s (N2), 1200 kb/s (N3), 2100 kb/s (N4), 3000 kb/s (N4) and the client terminal has a bandwidth of 3000 kb/s, it can request the content at any bit rate below this limit, for example, 2100 kb/s. In general, the content number i with the quality j (for example, the j^{th} quality level Nj described in the description file) is denoted “Ci@Nj”.

The service gateway GTW in this example is a home gateway, which ensures that the data is routed between a wide area network WAN and the decoder STB, manages the digital content, notably by ensuring that it is received from the network, and decodes it by virtue of the decoder STB.

In this example, in order to view content, the client terminal STB firstly polls the service gateway GTW to obtain an address of the desired description file of the content (for example, C1). The service gateway responds by providing the terminal with the address of the description file. Hereafter, it will be assumed that this file is a manifest type file according to the MPEG-DASH standard and reference will be equally made, depending on the context, to the expression “description file” or “manifest”.

Alternatively, this file can be directly retrieved from a local Internet server or from outside the local network, or can already be found on the service gateway or on the terminal at the time of the request.

An example of a manifest file, which will be described below with reference to FIG. 3, includes the description of content available in several different qualities (N1=400 kb/s, N2=800 kb/s, N3=1200 kb/s, etc.).

Once it has segment addresses corresponding to the desired content, the service gateway GTW proceeds to obtain segments via a download at these addresses. It should be noted that this downloading in this case is conventionally carried out through an HTTP URL, but also could be carried out through a universal address (URI) describing another protocol (dvb://mysegmentofcontent, for example).

The decoder STB is used to render a television program on the screen of the television TV. Hereafter, this television program is denoted by the content name C1. Such content C1 is described in a manifest file (see FIG. 3).

As a variant, it should be noted that the content C1 can be a television program broadcast off-line, or an on-demand video, or a personal video of the user, or any other multimedia content of determined duration, to which the invention also applies.

The decoder STB can be controlled by the user by means of a remote control. This remote control will allow tabs to be selected on a selection interface. The remote control can be physical or software.

FIG. 2 shows an architecture of a decoder STB according to one embodiment of the invention.

The decoder STB conventionally comprises memories M associated with a processor CPU. The memories can be of the ROM (Read Only Memory) or RAM (Random Access Memory) or even Flash type.

The decoder STB communicates with the gateway GTW via a first communication module COM1 and with the television TV via a second communication module COM2.

The first communication module COM1 is a Wi-Fi link, for example. The second communication module is an HDMI link, for example.

The decoder STB further comprises an adaptive progressive downloading module HAS capable of requesting progressive downloading of one item of content at one of the qualities proposed in a description file MNF.

The decoder STB further comprises a management entity ENT, which is the subject matter of the invention, the operation of which will be described hereafter.

The decoder STB can also contain other modules, such as a hard disk (not shown), for storing video segments, a module for controlling access to the content, a module for processing commands received from the smartphone.

A schematic view of main content C1 will now be shown with reference to FIG. 3, divided into segments and stored in the content server SRV. More specifically, the content server HAS exposes a video C1 in the form of segments C1i@Nj encoded at various encoding bit rates Nj, where the index i designates a temporal identifier of the segment C1i@Nj.

According to the prior art, the downloading module HAS, called conventional downloading mode hereafter, of the decoder STB is responsible for retrieving the segments from the content server HAS by selecting the video quality Nj as a function of the available network resource. The way in which the downloading module HAS selects the encoding bit rate of the next video segment to be downloaded is not described in further detail herein: indeed, many algorithms exist for making this selection, the strategies of which are more or less secure or aggressive. However, by way of a reminder, most often, the general principle of such algorithms is based on downloading a first segment at the lowest encoding bit rate proposed in the manifest file, and on evaluating the recovery time of this first segment. On this basis, the downloading module HAS evaluates whether, as a function of the size of the segment and of the time taken to retrieve it, the network conditions allow the next segment to be downloaded at a higher encoding bit rate. Some algorithms rely on a progressive increase in the quality level of the downloaded content segments, others propose more risky approaches, with jumps in the levels of the encoding bit rates of the successive segments.

In the conventional case, if a video segment lasts for 3 seconds, the retrieval of the segment by the downloading module HAS must not exceed 3 seconds, in order to allow uninterrupted rendering of the content by the decoder STB. Therefore, it is advisable that the downloading module HAS finds the best compromise between rendering quality, and therefore an encoding bit rate, that are as high as possible, and the downloading time of the segment, which must be low enough to allow continuous rendering on the television TV.

In the embodiment illustrated in FIG. 3, the downloading module HAS controls the downloading of a segment at the optimal encoding bit rate, as described in more detail hereafter.

Initially, the module HAS retrieves the manifest file MNF that corresponds to the video content C1 in order to discover the available segments of the video content C1, and the various associated video qualities Nj. In the example of FIG. 3, the content C1 is proposed, for example, in the form of 3 second duration segments, with a first encoding bit rate N1=400 kb/s, a second encoding bit rate N2=800 kb/s, a third encoding bit rate N3=1200 kb/s, etc.

In a normal operating mode, not illustrated in FIG. 3, the module HAS implements the downloading, for example, of the successive segments C11@N1 (that is the first time segment at an encoding bit rate of 400 kb/s), then C12@N3 (that is the second time segment at an encoding bit rate of 1200 kb/s), then C13@N3 (that is the third time segment at an encoding bit rate of 1200 kb/s), etc.

The various segments downloaded by the downloading module HAS are transmitted to a display module AFF capable of requesting a display on the screen of the television TV.

The algorithm implemented by the downloading module HAS to determine which segment must be downloaded at which encoding bit rate in normal operating mode can be one of the algorithms that already exists in the prior art. Therefore, this algorithm will not be described in further detail herein.

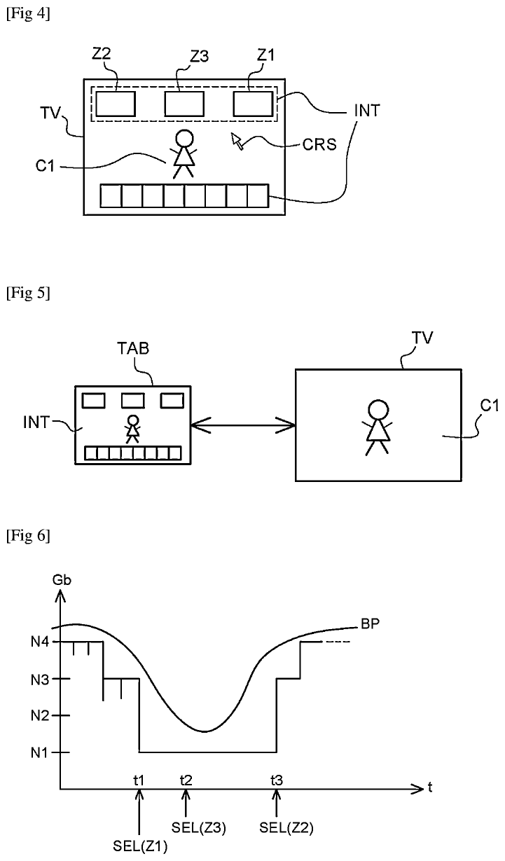

As indicated above, with reference to FIG. 4, in this example, a selection interface INT is accessible and can be rendered at the same time as the video content C1 on the same screen. In FIG. 4, the television content C1 is located in the background and the selection interface INT is located in the foreground.

According to an alternative embodiment, with reference to FIG. 5, the selection interface INT could also be rendered on a remote screen, for example, on a tablet TAB, a mobile telephone, or any other connected equipment equipped with a screen.

The interface INT could also be rendered both on the screen of the television and on a remote screen.

The method of the invention applies in the same way whether or not the rendering of the content and of the interface is carried out on the same screen.

The interface INT comprises at least one selectable zone Z1-Z3. More specifically, a zone is associated with a function. A function relates, for example, to access to a recorder, access to on-demand video, access to live broadcast content, access to settings, etc.

In the following example, the selection interface INT comprises selectable tabs located in three zones Z1, Z2 and Z3, respectively:
the tab of zone Z1 relates to access to on-demand video;
the tab of zone Z2 relates to access to live broadcast content, typically from television channels;
the tab of zone Z3 relates to access to content stored on a recorder.

The number of zones is unimportant.

In FIG. 4, a strip also appears at the bottom of the screen that includes a series of live content that is being broadcast and that can be selected from a remote control.

A cursor CRS can be moved over the interface and placed on the selection interface. In FIG. 4, the cursor is shown by means of an arrow.

Two types of action can be applied to the various tabs:
placing the cursor CRS on the tab, to be distinguished from execution or confirmation; in this case, an item of information makes the positioning of the cursor CRS visible on the screen; for example, the tab is highlighted, or even flashes;
execution or confirmation of the function associated with the tab; unlike positioning that involves identifying the tab on the screen on which the cursor CRS is placed, execution involves executing the function associated with the tab. The execution is generally carried out by pressing a confirmation key, for example, an “OK” key of a remote control.

In this example, the management entity ENT will modify how to download the segments as a function of a datum representing an interaction with the interface. The datum is a state of the cursor, for example. A state of the cursor CRS relates, for example, to the mobility of the cursor CRS on the selection interface, a location of the cursor CRS on the screen when the cursor is positioned on the screen, etc.

It is assumed that content C1 is being rendered on the screen TV. Depending on the state of the cursor CRS, the management entity ENT can request rendering of content other than the content being rendered.

For example, depending on the zone Z1-Z3 selected on the screen, the content can replace the content being rendered with other content. Within the context of adaptive downloading, the other content can be the same content but at a lower or even higher encoding bit rate. The entity ENT will therefore, depending on the state of the cursor, stipulate an encoding bit rate on the downloading module HAS. In this example, the stipulated encoding bit rate will be selected from among the bit rates that are lower than the bit rate conventionally computed using the techniques of the prior art described above, or even will be the lowest encoding bit rate from among the bit rates offered for the selection.

For example, if the selected zone is the tab ENR or VOD, this means that the user is interested in something other than the content being rendered; in this case, the entity ENT requires a reduction in the encoding bit rate from the downloading module HAS and continues rendering the content with this encoding bit rate.

By contrast, if the selected zone is the zone associated with the tab LIV, it can be assumed that the user will require execution of the function for accessing live content; in this case, the entity ENT requires normal operation from the downloading module HAS; the module HAS then conventionally accesses the segments based on the current bandwidth and by selecting an optimum bit rate with respect to this bandwidth. In this case, if the encoding bit rate has been lowered by the entity ENT, said entity requires resumption of downloading in a conventional manner.

For the above reasons, each tab Z1-Z3 will be associated with a value specifying whether particular processing needs to be applied, for example, a reduction in the encoding bit rate below the bit rate that conventionally would be selected.

In this example, a binary value (0 or 1) is associated with the zones/tabs signifying whether or not to decrease the encoding bit rate.
Zone Z1—binary code 1
Zone Z2—binary code 0
Zone Z3—binary code 1

All other values could have been used in association with a zone, with the aim of this value being to distinguish two types of zone, with this distinction then allowing particular processing to be carried out or not to be carried out.

If a tab Z1-Z3 is selected, the management entity ENT checks the associated code and modifies or does not modify its operation for downloading future segments:
Code 1: a specific selection mode is implemented; in this mode, the entity ENT requires the selection of a bit rate from the downloading module that is lower than that which would be requested in the conventional mode;
Code 0: the entity requires normal operation from the downloading module; the conventional bandwidth selection mode based on the bandwidth is implemented.

According to the invention, in the specific mode, the encoding bit rate is selected as a function of a state of the cursor. It will be seen hereafter that the state of the cursor CRS relates to several embodiments. Indeed, the state can relate to a location of the cursor, or a mobility state (if it is mobile or immobile), etc.

FIG. 6 illustrates one embodiment. This FIG. 6 illustrates the evolution of the encoding bit rate selected by the downloading module HAS as a function of time and the selection of the encoding bit rates as a function of time depending on the state of the cursor CRS, namely, in this example, the location of the cursor on the screen and the binary code associated with the zone.

In the example, the current access bandwidth BP (generally expressed in GB for Giga Bytes) to the network RES varies over time.

Four encoding bit rates N1-N4 are considered to be available for the content to be downloaded C1.

The start of downloading begins at the instant t0.

From the instant t0 to the instant t1, no tab is considered to be selected via the cursor. The downloading module HAS conventionally selects a first maximum bit rate N4 for the main content C1 that is less than the bandwidth, and receives segments with this encoding bit rate N4. Secondly, with the bandwidth decreasing, the module selects the bit rate N3 with the same principle.

Hereafter, the positioning of the cursor CRS will be illustrated in the form of hatching in the selected tab.

At the instant t1, with reference to FIG. 6, the cursor CRS moves following the receipt of a command originating from a control device. At this instant t1, the cursor CRS is positioned on the zone Z1; the zone Z1 of the selection interface is selected SEL(Z1); this zone Z1 is hatched in FIG. 6; on the screen, this zone could be highlighted in order to highlight the location of the selection on the screen TV. Following the selection of the zone Z1, the management entity ENT checks the binary code associated with the zone Z1, namely binary code 1. In this case, as explained above, the entity manages the downloading according to a specific selection mode in which the entity selects a bit rate that is lower than that which would be requested in the conventional mode. In this example, the entity selects the minimum encoding bit rate N1.

The minimum encoding bit rate is selected for the future segments as long as the zone Z1 is selected, i.e., up to an instant t2.

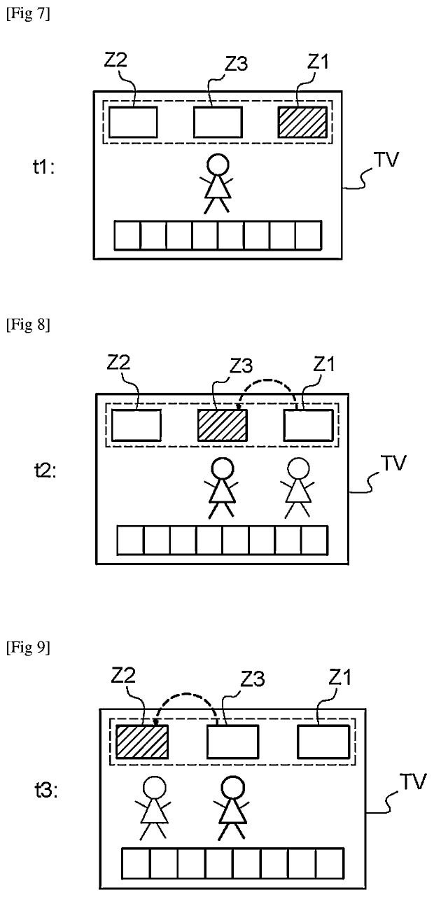

At this instant t2, with reference to FIG. 7, the cursor CRS moves and is positioned in the zone Z3 that is selected. Following the selection of the zone Z3 (which is hatched in FIG. 3), the management entity ENT checks the binary code associated with the zone, namely binary code 1. In this case, as explained above, the entity manages the downloading according to a specific selection mode in which the entity selects a bit rate that is lower than that which would be requested in the conventional mode. In this example, the entity continues to select the minimum encoding bit rate N1.

The minimum encoding bit rate N1 is selected for the future segments as long as the zone Z1 is selected, i.e., up to an instant t3.

At this instant t3, with reference to FIG. 8, the cursor CRS moves over the zone Z2. Following the selection of the zone Z2, the management entity ENT checks the binary code associated with the zone, namely binary code 0. In this case, as explained above, the entity requires conventional HAS downloading by selecting an optimal encoding bit rate in terms of quality, namely N3 and then N4 in the figure.

The above embodiment is based on the location of the cursor CRS on the screen. According to another embodiment, the mobility of the cursor CRS can be taken into account. In this case, if the cursor CRS is mobile, a binary code 1 is associated with this mobility; the specific processing manages the downloading in the specific manner defined above. In this case, as explained above, the entity ENT manages the downloading according to a specific selection mode in which the entity requires the selection of a lower bit rate than that which would be requested in the conventional mode by the downloading module HAS. In this example, the entity selects the minimum encoding bit rate N1.

If the cursor CRS is immobile, a binary code 0 is associated with this state. In this case, as explained above, the entity conventionally manages the downloading by selecting a maximum encoding bit rate which is less than the current bandwidth.

Finally, it should also be noted in this case that the term module or the term entity can equally correspond to a software component or to a hardware component or to a set of hardware and software components, with a software component itself corresponding to one or more computer programs or sub-programs, or more generally to any element of a program capable of implementing a function or a set of functions as described for the relevant modules. Similarly, a hardware component corresponds to any element of a hardware assembly able to implement a function or a set of functions for the relevant module (integrated circuit, smart card, memory card, etc.).

Although the present disclosure has been described with reference to one or more examples, workers skilled in the art will recognize that changes may be made in form and detail without departing from the scope of the disclosure and/or the appended claims.

1. A management method implemented by a management entity device and comprising:
managing rendering of content on a screen, with the content having several qualities available for selection, the rendering of the content being associated with a selection interface, that the managing comprising selecting, when the content is rendered, the quality for rendering the content as a function of a datum representing an interaction with the selection interface.

2. The management method as claimed in claim 1, wherein the interface is capable of being manipulated by using a cursor and the datum representing an interaction is a state of the cursor in conjunction with the selection interface.

3. The management method as claimed in claim 1, wherein the content is divided into several segments, with the segments having several selectable encoding bit rates, the content is being downloaded from a communication network with a given encoding bit rate, and the state of the cursor determines the encoding bit rate of the segments to be selected for future segments of the content.

4. The management method as claimed in claim 3, wherein the determined encoding bit rate is less than a current encoding bit rate.

5. The management method as claimed in claim 3, wherein the determined encoding bit rate is a smallest of the several selectable encoding bit rates.

6. The management method as claimed in claim 2, wherein the state is a movement of the cursor on the selection interface.

7. The management method as claimed in claim 2, wherein the state is a location of the cursor on the selection interface.

8. The method as claimed in claim 1, wherein the content is being downloaded from a communication network with a given encoding bit rate, the selection interface comprises at least one selection zone associated with a function, with the content being rendered being a given type of content, and in response to the function associated with the zone relating to access to said type of content being rendered, the encoding bit rate is a maximum possible bit rate as a function of a current bandwidth.

9. A management entity comprising:
at least one processor; and
at least one non-transitory computer readable medium comprising instructions stored thereon which when executed by the at least one processor configure the management entity to manage rendering of content on a screen, with the content having several qualities available for selection, the rendering of the content being associated with a selection interface, wherein the managing comprises selecting, when the content is rendered, the quality for rendering the content as a function of a datum representing an interaction with the selection interface.

10. A reader terminal comprising the management entity as defined in claim 9.

11. (canceled)

12. A non-transitory computer readable data medium storing at least one series of program code instructions for executing a method of managing rendering of content on a screen, when the instructions are executed by at least one processor, wherein the content has several qualities available for selection and the rendering of the content is associated with a selection interface, and wherein the managing comprises:
selecting, when the content is rendered, the quality for rendering the content as a function of a datum representing an interaction with the selection interface.
